(19) United States
(12) Patent Application Publication
(10) Pub. No.: US 2011/0148841 A1
(43) Pub. Date: Jun. 23, 2011

(54) DRIVING CIRCUIT AND DISPLAY APPARATUS HAVING THE SAME

(75) Inventors: Jang-Hyun YEO, Seoul (KR); YongSoon LEE, Cheonan-si (KR); Po-Yun PARK, Asan-si (KR); OckJin KIM, Asan-si (KR); Seunghwan MOON, Asan-si (KR); Junghwan CHO, Goyang-si (KR)

(73) Assignee: SAMSUNG ELECTRONICS CO., LTD, Suwon-si (KR)

(21) Appl. No.: 12/815,773

(22) Filed: Jun. 15, 2010

(30) Foreign Application Priority Data
Dec. 22, 2009 (KR) 10-2009-0128920

(51) Int. Cl. G09G 5/00

(52) U.S. Cl. 345/211

(57) ABSTRACT

A driving circuit includes; a timing controller, a first gamma reference voltage generating circuit, and a data driver. The timing controller receives an external signal to output an image signal and a control signal for a single frame. The first gamma reference voltage generating circuit outputs first, second, third and fourth gamma reference voltages. The data driver includes a second gamma reference voltage generating circuit, a digital-to-analog converter and a selector. The second gamma reference voltage generating circuit outputs at least one fifth gamma reference voltage and at least one sixth gamma reference voltage based on the control signal.

This application claims priority to Korean Patent Application No. 2009-128920, filed on Dec. 22, 2009, and all the benefits accruing therefrom under 35 U.S.C. §119, the content of which in its entirety is herein incorporated by reference.

### BACKGROUND OF THE INVENTION

1. Field of the Invention

The present invention relates to a driving circuit and a display apparatus having the same. More particularly, the present invention relates to a driving circuit capable of reducing the number of signal transmission lines thereof and a display apparatus having the driving circuit.

2. Description of the Related Art

In general, a liquid crystal display (“LCD”) includes an LCD panel to display an image and a driving circuit to drive the LCD panel.

The LCD panel typically includes a liquid crystal cell formed in each of a plurality of pixel regions and a thin film transistor connected to a gate line, a data line and the liquid crystal cell in each of the plurality of pixel regions.

The driving circuit typically includes a gate driver and a data driver. The gate driver applies signals to the gate line and the data driver applies signals to the data line. The gate driver typically sequentially provides a scan signal to the plurality of gate lines.

The data driver converts a digital data signal to an analog signal using a plurality of gamma voltages each having a different voltage level. In other words, the data driver selects a gamma voltage corresponding to a gray level of the digital data signal and provides the selected gamma voltage to a specific data line of the plurality of data lines in response to at least one control signal.

In the above configuration, the LCD requires a plurality of signal lines to provide the data driver with control signals and gamma voltages, so it is difficult to make the LCD smaller in size.

### BRIEF SUMMARY OF THE INVENTION

Exemplary embodiments of the present invention provide a driving circuit capable of reducing the number of signal transmission lines thereof.

Exemplary embodiments of the present invention also provide a display apparatus having the driving circuit.

According to one exemplary embodiment, the driving circuit includes; a timing controller which receives an external signal and outputs an image signal and a control signal for a single frame, a first gamma reference voltage generating circuit which outputs a first gamma reference voltage, a second gamma reference voltage, a third gamma reference voltage and a fourth gamma reference voltage, wherein the third gamma reference voltage and the fourth gamma reference voltage have a different polarity from the first gamma reference voltage and the second gamma reference voltage with respect to a predetermined reference voltage, and a data driver which receives the first to fourth gamma reference voltages, the image signal, and the control signal and outputs a data voltage, wherein the data driver includes; a second gamma reference voltage generating circuit which outputs at least one fifth gamma reference voltage and at least one sixth gamma reference voltage based on the control signal, wherein the fifth gamma reference voltage has a substantially similar voltage level as one of a voltage level of the first gamma reference voltage, a voltage level of the second gamma reference voltage, and a voltage level between the first gamma reference voltage and the second gamma reference voltage and wherein the sixth gamma reference voltage has a substantially similar voltage level as one of a voltage level of the third gamma reference voltage, a voltage level of the fourth gamma reference voltage, and a voltage level between the third gamma reference voltage and the fourth gamma reference voltage, a digital-to-analog (“D/A”) converter which converts the image signal to a first data voltage based on the first gamma reference voltage, second gamma reference voltage and fifth gamma reference voltage and converts the image signal to a second data voltage based on the third gamma reference voltage, fourth gamma reference voltage, and sixth gamma reference voltage, and a selector which receives the first data voltage and the second data voltage to output one of the first data voltage and the second data voltage as the data voltage.

In one exemplary embodiment, the driving circuit may further include a transmission line which connects the timing controller to the data driver to provide the data control signal and the gamma control signal to the data driver during a blank period of an image cycle and to provide the image signal to the data driver during a data transmission period of the image cycle.

According to another exemplary embodiment, the display apparatus includes; a timing controller which receives an external signal to provide an image signal and a control signal for a single frame, a display panel which displays an image in response to the image signal, a first gamma reference voltage generating circuit which outputs a first gamma reference voltage, a second gamma reference voltage, a third gamma reference voltage and a fourth gamma reference voltage, wherein the third gamma reference voltage and the fourth gamma reference voltage having a different polarity from the first gamma reference voltage and the second gamma reference voltage with respect to a predetermined reference voltage, and a data driver which receives the first to fourth gamma reference voltages, the image signal, and the control signal to generate a data voltage, wherein the data driver includes; a second gamma reference voltage generating circuit which outputs at least one fifth gamma reference voltage and at least one sixth gamma reference voltage based on the control signal, the fifth gamma reference voltage having a substantially same voltage level as a voltage level of the first gamma reference voltage, a voltage level of the second gamma reference voltage, or a voltage level between the first gamma reference voltage and second gamma reference voltage and the sixth gamma reference voltage having a substantially same voltage level as a voltage level of the third gamma reference voltage, a voltage level of the fourth gamma reference voltage, or a voltage level between the third gamma reference voltage and the fourth gamma reference voltage, a D/A converter which converts the image signal to a first data voltage based on the first gamma reference voltage, second gamma reference voltage, and fifth gamma reference voltage and converts the image signal to a second data voltage based on the third gamma reference voltage, fourth gamma reference voltage, and sixth gamma reference voltage, and a selector which receives the first data voltage and the second data voltage to output either the first data voltage or the second data voltage as the data voltage.

According to the above, the data control signal and the gamma control signal are transmitted during the blank period of the image signal cycle before the image signal is transmitted, thereby reducing the number of signal transmission lines through which the data control signal and the gamma control signal are transmitted. Moreover, since the gamma reference voltages are generated using the first gamma reference voltage generating circuit and the second gamma reference voltage generating circuit provided in the data driver, the number of signal transmission lines connected between the first gamma reference voltage generating circuit and the data driver can be reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating an exemplary embodiment of a liquid crystal display (“LCD”) according to the present invention;

FIG. 2 is a block diagram illustrating an exemplary embodiment of a data driver of FIG. 1;

FIG. 3 is a circuit diagram illustrating exemplary embodiments of a second gamma reference voltage generating circuit and a digital-to-analog (“D/A”) converter of the data driver of FIG. 2;

FIG. 4 is a circuit diagram illustrating another exemplary embodiment of a second gamma reference voltage generating circuit and a D/A converter of another exemplary embodiment of a data driver according to the present invention;

FIG. 5 is a timing diagram of signals input from signal transmission lines provided between an exemplary embodiment of a timing controller and the exemplary embodiment of a data driver of FIG. 1 during an image output cycle wherein image signals are output to an LCD panel; and

FIG. 6 is a graph illustrating simulation results of transmittance as a function of gray level using 6, 8 and 12 gamma reference voltages, respectively.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

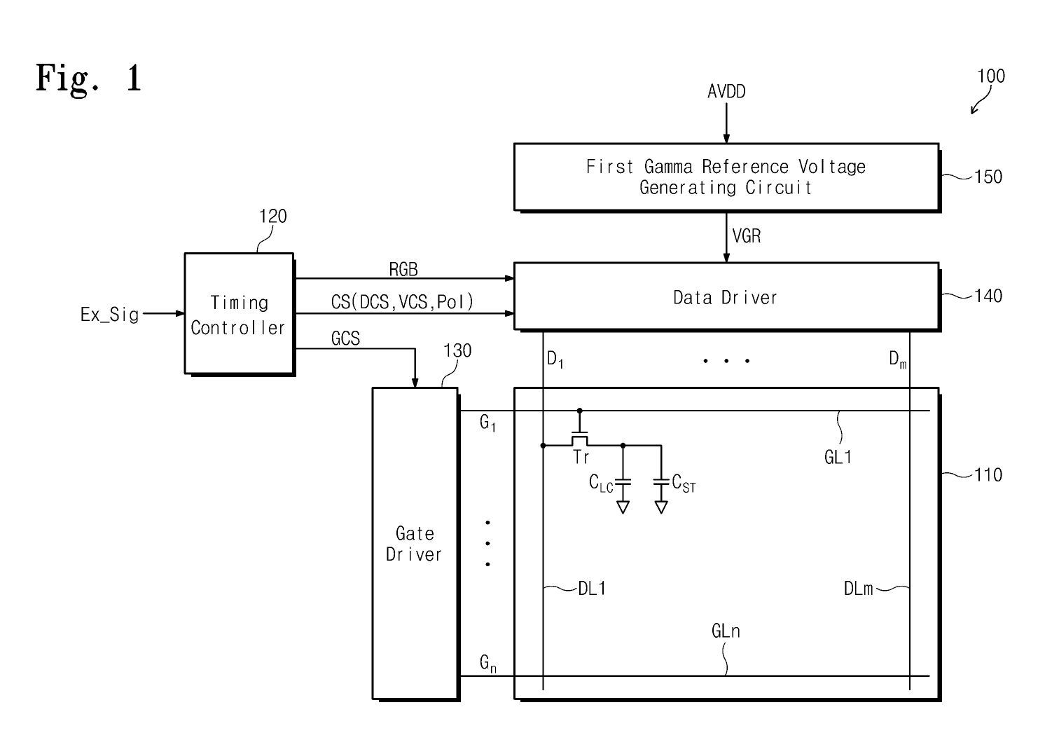

FIG. 1 is a block diagram illustrating an exemplary embodiment of a liquid crystal display (“LCD”) according to the present invention.

Referring to FIG. 1, an LCD 100 includes a LCD panel 110, a timing controller 120, a gate driver 130, a data driver 140 and a first gamma reference voltage generating circuit 150.

The LCD panel 110 includes a plurality of gate lines GL1˜GLn, a plurality of data lines DL1˜DLm disposed substantially perpendicular to the gate lines GL1˜GLn, and a plurality of pixels. In the present exemplary embodiment, each of the plurality of pixels have substantially the same structure and function, thus one pixel is depicted as an example for the sake of convenience of explanation. In the present exemplary embodiment, each pixel includes a thin film transistor Tr, a liquid crystal capacitor C_{LC}, and a storage capacitor C_{ST}. The thin film transistor Tr includes a gate electrode connected to a corresponding gate line of the plurality of gate lines GL1˜Gln, a source electrode connected to a corresponding data line of the plurality of data lines DL1˜DLm, and a drain electrode connected to the liquid crystal capacitor C_{LC} and the storage capacitor C_{ST}. Alternative exemplary embodiments include configurations wherein the storage capacitor C_{ST} is omitted.

The timing controller 120 receives an external signal Ex_Sig from an external device (not shown). The timing controller 120 converts a data format of the external signal Ex_Sig into a data format appropriate to an interface between the timing controller 120 and the data driver 140 and outputs an image signal RGB and a control signal CS to the data driver 140. Furthermore, the timing controller 120 outputs a gate control signal GCS to a gate driver 130.

The gate driver 130 sequentially applies gate signals G1˜Gn to the gate lines GL1˜GLn of the LCD panel 110, respectively, in response to the gate control signal GCS provided from the timing controller 120 to sequentially scan the gate lines GL1˜GLn.

The first gamma reference voltage generating circuit 150 receives an analog driving voltage AVDD from an exterior (not shown) and outputs a plurality of gamma reference voltages VGR to the data driver 140.

The data driver 140 generates a plurality of gray scale voltages using the gamma reference voltages VGR provided from the first gamma reference voltage generating circuit 150. The data driver 140 selects data voltages corresponding to the image signal RGB from among the gray scale voltages in response to the image signal RGB from the timing controller 120 and applies the selected data voltages as data signals D1˜Dn to the data lines DL1˜DLm of the liquid crystal panel 110.

If a gate signal is applied to a selected gate line of the plurality of gate lines GL1˜GLn, a thin film transistor Tr connected to the selected gate line is turned on in response to the corresponding gate signal. Thus, the data signal applied to the data line connected to the turned-on thin film transistor Tr is charged in the liquid crystal capacitor C_{LC} and the storage capacitor C_{ST} through the turned-on thin film transistor Tr.

The liquid crystal capacitor C_{LC} controls light transmission of a liquid crystal layer including liquid crystal molecules (not shown) disposed in the liquid crystal panel 110 corresponding to the liquid crystal capacitor C_{LC} according to the charged voltage of the liquid crystal capacitor C_{LC}. In the exemplary embodiment where it is present, the storage capacitor C_{ST} is charged with the data signal provided through the corresponding data line when the thin film transistor Tr is turned on. Then, the storage capacitor C_{ST} applies the charged data signal to the liquid crystal capacitor C_{LC} to maintain the charge of the liquid crystal capacitor C_{LC} when the thin film transistor Tr is turned off. The LCD panel 110 can display a desired image through the above-described method.

Although not shown in FIG. 1, exemplary embodiments of the LCD 100 may further include a backlight unit (not shown). The backlight unit is disposed at a side or rear of the LCD panel 110 and provides a light to the LCD panel 110.

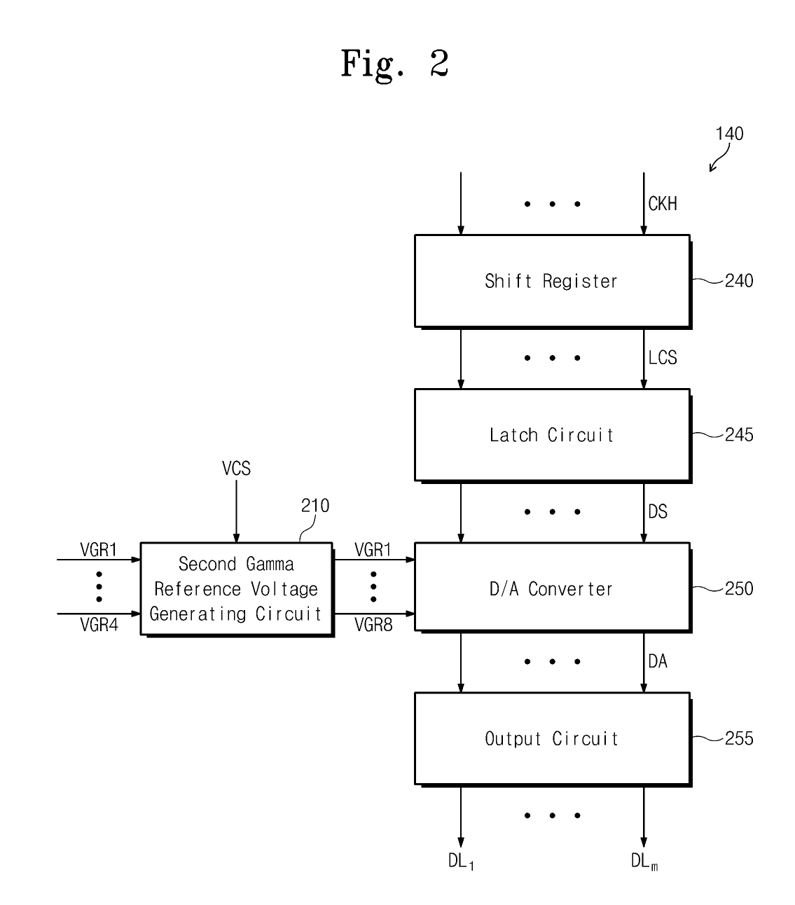

FIG. 2 is a block diagram illustrating an exemplary embodiment of the data driver 140 of FIG. 1.

The data driver 140 includes a shift register 240, a latch circuit 245, a digital-to-analog converter (hereinafter, referred to as “D/A” converter) 250, a second gamma reference voltage generating circuit 210 and an output circuit 255. The shift register 240 receives a clock signal CKH and outputs a control signal LCS to the latch circuit 245. The latch circuit 245 stores data line by line in response to the control signal LCS from the shift register 240 and outputs the stored data DS a single line at a time.

The second gamma reference voltage generating circuit 210 receives four gamma reference voltages VGR1˜VGR4 from the first gamma reference voltage generating circuit 150 and a gamma control signal VCS from the timing controller 120 and outputs eight gamma reference voltages VGR1˜VGR8 to the D/A converter 250.

As another exemplary embodiment, the second gamma reference voltage generating circuit 210 may receive four gamma reference voltages VGR1˜VGR4 from the first gamma reference voltage generating circuit 150 and a gamma control signal VCS from the timing controller 120 to generate only four gamma reference voltages VGR5˜VGR8. In such an alternative exemplary embodiment, four gamma reference voltages VGR1˜VGR4 from the first gamma reference voltage generating circuit 150 may be input directly to the D/A converter 250. That is, in such an alternative exemplary embodiment the four gamma voltages VGR1˜VGR4 are input to both the second gamma reference voltage generating circuit 210 and to the D/A converter 250 while the D/A converter converts the four gamma voltages VGR1˜VGR4

The D/A converter 250 receives the eight gamma reference voltages VGR1˜VGR8 from the second gamma reference voltage generating circuit 210, or, in an alternative exemplary embodiment, from the first gamma reference voltage generating circuit 150 and the second gamma reference voltage generating circuit 210, and selects analog data voltages corresponding to the data DS provided from the latch circuit 245. The D/A converter 250 transmits the selected data voltages DV to the output circuit 255 and the output circuit 255 applies the data voltages DV to the data lines DL1˜DLm.

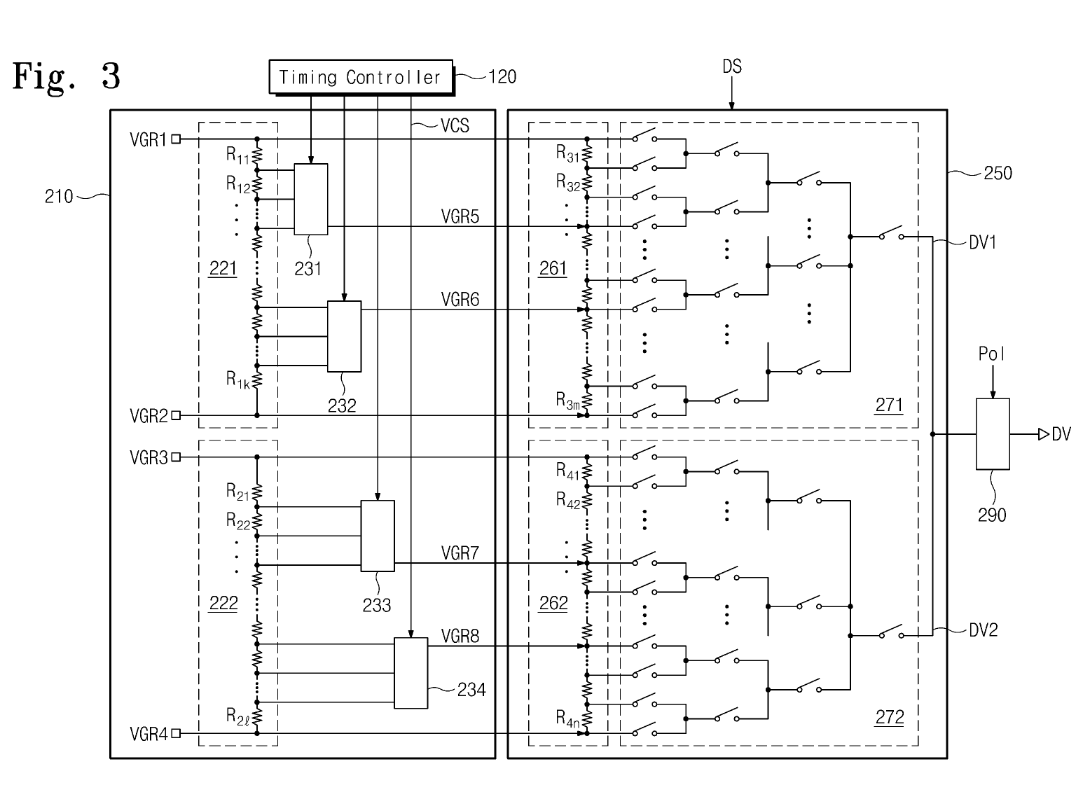

FIG. 3 is a circuit diagram illustrating an exemplary embodiment of the second gamma reference voltage generating circuit 210 and the D/A converter 250 of FIG. 2.

The first gamma reference voltage generating circuit 150 receives the analog driving voltage AVDD to output the first gamma reference voltage VGR1, the second gamma reference voltage VGR2, the third gamma reference voltage VGR3 and the fourth gamma reference voltage VGR4 to the data driver 140, as described above. The first gamma reference voltage VGR1 has a different polarity from that of the fourth gamma reference voltage VGR4 with respect to a predetermined reference voltage and the second gamma reference voltage VGR2 has a different polarity from that of the third gamma reference voltage VGR3 with respect to the predetermined reference voltage. That is, in one exemplary embodiment, the first gamma reference voltage VGR1 has a same polarity as that of the second gamma reference voltage VGR2 with respect to the predetermined reference voltage and the third gamma reference voltage VGR3 has a same polarity as that of the fourth gamma reference voltage VGR4 with respect to the predetermined reference voltage.

The second gamma reference voltage generating circuit 210 receives the first to fourth gamma reference voltages VGR1˜VGR4 from the first gamma reference voltage generating circuit 150. The second gamma reference voltage generating circuit 210 includes a first resistor string 221, a second resistor string 222 (outlined by dashed-line boxes), a first decoder 231, a second decoder 232, a third decoder 233 and a fourth decoder 234.

The first resistor string 221 includes a plurality of first resistors R₁₁-R₁ₖ, where k is a natural number, and the first resistors R₁₁-R₁ₖ are connected in series between the first and second gamma reference voltages VGR1 and VGR2. The second resistor string 222 includes a plurality of second resistors R₂₁-R₂ₗ, where 1 is a natural number, and the second resistors R₂₁-R₂ₗ are connected in series between the third and fourth gamma reference voltages VGR1 and VGR2.

In the present exemplary embodiment, the control signal CS output from the timing controller 120 includes a data control signal DCS and a gamma control signal VCS. The timing controller 120 applies the gamma control signal VCS to the first to fourth decoders 231, 232, 233 and 234.

The first and second decoders 231 and 232 respectively output voltages at two different nodes where the first resistors R₁₁-R₁ₖ are connected as the fifth gamma reference voltage VGR5 and the sixth gamma reference voltage VGR6 in response to the gamma control signal VCS. The third and fourth decoders 233 and 234 respectively output voltages at two different nodes where the second resistors R₂₁-R₂ₗ are connected as the seventh gamma reference voltage VGR7 and the eighth gamma reference voltage VGR8 in response to the gamma control signal VCS. Specifically, the first decoder 231 is connected to all of the nodes between consecutive first resistors R₁₁-R₁ₖ corresponding thereto and the second decoder 232 is connected to all of the nodes between consecutive first resistors R₁₁-R₁ₖ corresponding thereto, e.g., all remaining first resistor nodes.

The present exemplary embodiment of a D/A converter 250 includes a third resistor string 261, a fourth resistor string 262, a first switch circuit 271 and a second switch circuit 272.

The third resistor string 261 includes a plurality of third resistors R₃₁-R₃ₘ, where m is a natural number, and the third resistors R₃₁-R₃ₘ are connected in series between the first and second gamma reference voltages VGR1 and VGR2. The first and second decoders 231 and 232 are respectively connected to two different nodes where the third resistors R₃₁-R₃ₘ are connected to respectively output the fifth and sixth gamma reference voltages VGR5 and VGR6. The third resistor string 261 receives the first, second, fifth, and sixth gamma reference voltages VGR1, VGR2, VGR5 and VGR6 and the nodes at which the third resistors R₃₁-R₃ₘ are connected output a plurality of first gray scale voltages, specifically, the voltage potential at each of the nodes of the third resistor string correspond to the plurality of first gray scale voltages, respectively.

The fourth resistor string 262 includes a plurality of fourth resistors R₄₁-R₄ₙ, where n is a natural number, and the fourth resistors R₄₁-R₄ₙ are connected in series between the third and fourth gamma reference voltages VGR3 and VGR4. The third and fourth decoders 233 and 234 are respectively connected to two different nodes where the fourth resistors R₄₁-R₄ₙ are connected and respectively output the seventh and eighth gamma reference voltages VGR 7 and VGR 8. The fourth resistor string 262 receives the third, fourth, seventh, and eighth gamma reference voltages VGR3, VGR4, VGR7 and VGR8 and the nodes at which the fourth resistors R₄₁-R₄ₙ are connected output a plurality of second gray scale voltages, specifically, the voltage potential at each of the nodes of the fourth resistor string correspond to the plurality of second gray scale voltages, respectively.

The first switch circuit 271 includes a plurality of switches and is connected to the nodes where the third resistors R₃₁-R₃ₘ are connected to receive the first gray scale voltages. The second switch circuit 272 includes a plurality of switches and is connected to the nodes where the fourth resistors R₄₁-R₄ₙ are connected to receive the second gray scale voltages. The first switch circuit 271 receives the data DS from the latch circuit 245 to output one of the first gray scale voltages as a first data voltage DV1 and the second switch circuit 272 receives the data DS from the latch circuit 245 to output one of the second gray scale voltages as a second data voltage DV2.

In one exemplary embodiment, the data driver 140 may further include a selector 290. In such an exemplary embodiment, the control signal CS output from the timing controller 120 may further include a polarity control signal Pol. The selector 290 receives the first data voltage DV1 and the second data voltage DV2 and outputs either the first data voltage DV1 or the second data voltage DV2 as a data voltage DV according to the polarity control signal Pol. The selector 290 may be, but is not limited to, a multiplexer that selects and outputs either the first data voltage DV1 or the second data voltage DV2 in response to the polarity control signal Pol.

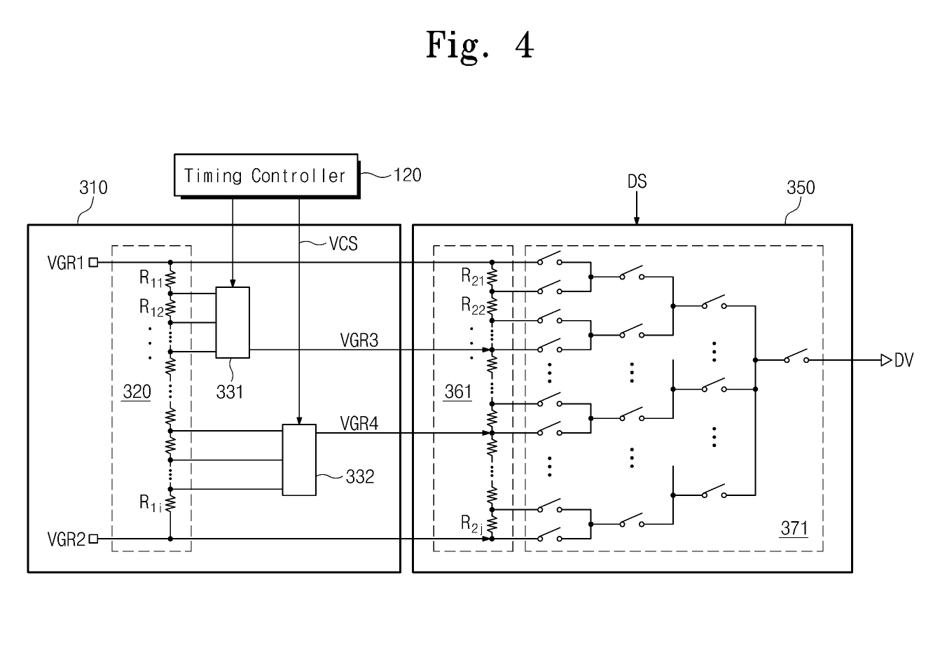

FIG. 4 is a circuit diagram illustrating another exemplary embodiment of a second gamma reference voltage generating circuit 310 and another exemplary embodiment of a D/A converter 350 of the data driver 140 according to the present invention.

In the present exemplary embodiment, although not shown in the figures, a first gamma reference voltage generating circuit 150 receives an analog driving voltage AVDD from an exterior source and outputs a first gamma reference voltage VGR1 and a second gamma reference voltage VGR2 to the data driver 140. The second gamma reference voltage generating circuit 310 includes a first resistor string 320, a first decoder 331 and a second decoder 332 and receives the first and second gamma reference voltages VGR1 and VGR2 from the first gamma reference voltage generating circuit 150.

The first resistor string 320 includes a plurality of first resistors R₁₁-R₁ᵢ where i is a natural number, and the first resistors R₁₁-R₁ᵢ are connected in series between the first and second gamma reference voltages VGR1 and VGR2.

The control signal CS output from the timing controller 120 includes a data control signal DCS and a gamma control signal VCS. The timing controller 120 applies the gamma control signal VCS to the first and second decoders 331 and 332 and applies the image signal RGB to the D/A converter 350.

Responsive to the gamma control signal VCS, the first and second decoders 331 and 332 respectively output voltages at two different nodes where the first resistors R₁₁-R₁ᵢ are connected as a third gamma reference voltage VGR3 and a fourth gamma reference voltage VGR4.

In the present exemplary embodiment, the D/A converter 350 includes a single second resistor string 361 and a single switch circuit 371.

The second resistor string 361 includes a plurality of second resistors R₂₁-R₂ⱼ, where j is a natural number, and the second resistors R₂₁-R₂ⱼ are connected in series between the first and second gamma reference voltages VGR1 and VGR2. The first and second decoders 331 and 332 output the third and fourth gamma reference voltages VGR3 and VGR4 from two different nodes where the second resistors R₂₁-R₂ⱼ are connected, respectively. The second resistor string 361 receives the first to fourth gamma reference voltages VGR1, VGR2, VGR3 and VGR4 and the nodes at which the second resistors R₂₁-R₂ⱼ are connected output a plurality of gray scale voltages; that is, the voltage potential at each of the nodes of the second resistor string correspond to the plurality of gray scale voltages, respectively.

The switch circuit 371 includes a plurality of switches and is connected to the nodes at which the second resistors R₂₁-R₂ⱼ are connected to receive the gray scale voltages. The switch circuit 371 receives the data DS from the latch circuit 245 and outputs one of the gray scale voltages as a data voltage DV.

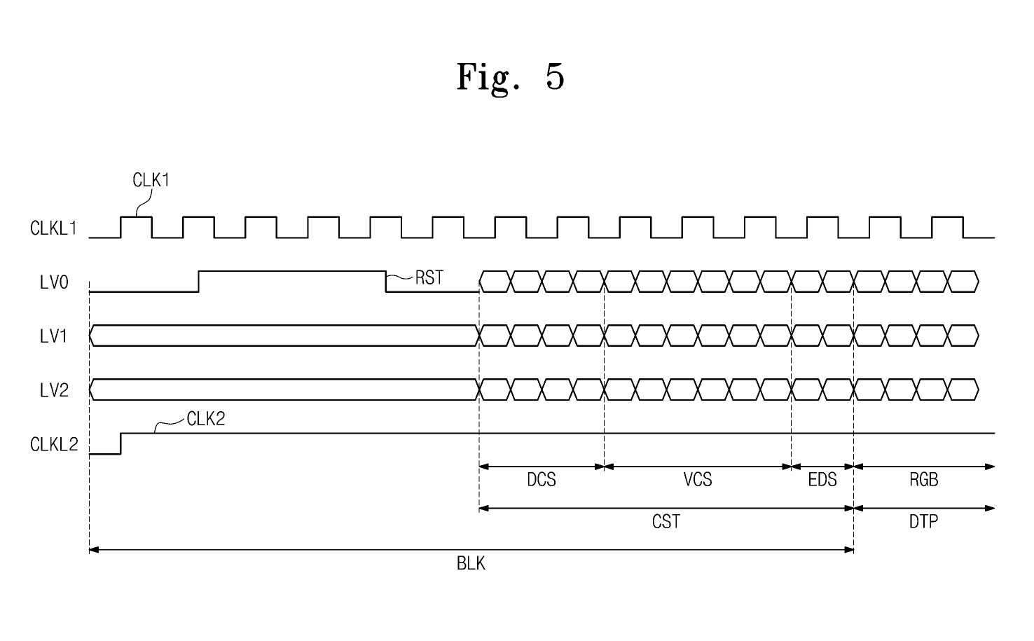

FIG. 5 is a timing diagram of signals input from signal transmission lines provided between the timing controller 120 and the data driver 140 of FIG. 1 during an image output cycle wherein image signals are output to the LCD panel 110.

In FIG. 5, a first clock signal line CLKL1 to which a first clock signal CLK1 is applied, a second clock signal line CLKL2 to which a second clock signal CLK2 is applied, a first data transmission line LVO, a second data transmission line LV1, and a third data transmission line LV2 have been shown as an example, but the present invention is not be limited thereto or thereby.

The timing controller 120 repeatedly transmits the image signal RGB to the data driver 140 for each frame and a blank period BLK exists between two subsequent frames in the data transmission lines LV0, LV1 and LV2. If a predetermined time period, for example a time period corresponding to one clock period of the first clock signal CLK1, passes after the second clock signal CLK2 becomes high in the blank period BLK, a reset signal RST is applied to the first data transmission line LV0. The reset signal RST becomes low after the reset signal RST is maintained at high state for a time period corresponding to three clock periods of the first clock signal CLK1. Then, if a time period corresponding to 7.5 clock periods of the first clock signal CLK1 passes after the reset signal RST switches to a low state, the image signal RGB begins transmission through the first to third data transmission lines LV0, LV1 and LV2. Hereinafter, a time period for which the image signal RGB is transmitted is referred to as a data transmission period DTP and a time period for which the control signal CS is transmitted from a time at which the reset signal RST becomes low to a time at which the data transmission period DTP starts is referred to as a control signal transmission period CST.

As shown in FIG. 5, the first to third data transmission lines LV0, LV1 and LV2 transmit the control signal (e.g., the data control signal DCS and the gamma control signal VCS) to the data driver 140 during the control signal transmission period CST.

For example, the timing controller 120 transmits the data control signal DCS during a time period corresponding to two clock periods of the first clock signal CLK1 at a time point at which 1.5 clock periods of the first clock signal CLK1 passes after the reset signal RST switches to a low state. Then, the timing controller 120 transmits the gamma control signal VCS during a time period corresponding to three clock periods of the first clock signal CLK1. The timing controller 120 may transmit the image signal RGB and the control signal CS at the rising and falling times of the first clock signal CLK1.

In one exemplary embodiment, the control signal CS may further include an error detection signal EDS to detect whether the data control signal DCS and the gamma control signal VCS are transmitted successfully. Exemplary embodiments of the error detection signal EDS may be a checksum value or a parity bit value of the transmitted signals. Moreover, the data driver 140 detects existence of error in the signal transmission by comparing a predetermined value of the transmitted control signal with the error detection signal EDS. If transmission errors of the data control signal DCS and the gamma control signal VCS are detected, the data driver 140 may repeat the output of a data voltage of a previous frame.

In the exemplary embodiment where it is present, the timing controller 120 transmits the error detection signal EDS for a time period corresponding to one clock period after the gamma control signal VCS is transmitted. The number of clock periods required to transmit the data control signal DCS, the gamma control signal VCS, and the error detection signal EDS may be changed and also their transmission order may be changed. Exemplary embodiments include configurations wherein the error detection signal EDS may be transmitted after the data control signal DCS and the gamma control signal VCS are transmitted in order to ensure accurate transmission of the data control signal DCS and the gamma control signal VCS. In the present exemplary embodiment, the first to third data transmission lines LV0, LV1 and LV2 transmit the image signal RGB after the error detection signal EDS is transmitted.

In one exemplary embodiment, the control signals related to the image signal RGB and the data voltage and the polarity control signal Pol may be transmitted during the blank period BLK prior to the data transmission period DTP. Furthermore, in another exemplary embodiment the number of control signals that can be transmitted during the blank period BLK may be changed depending on a time length of the blank period BLK.

The timing controller 120 may further include an encoder (not shown) to encode at least one portion of the image signal RGB or the control signal CS transmitted during the blank period BLK. In addition, the data driver 140 may further include a decoder (not shown) to decode the encoded image signal or the encoded control signal.

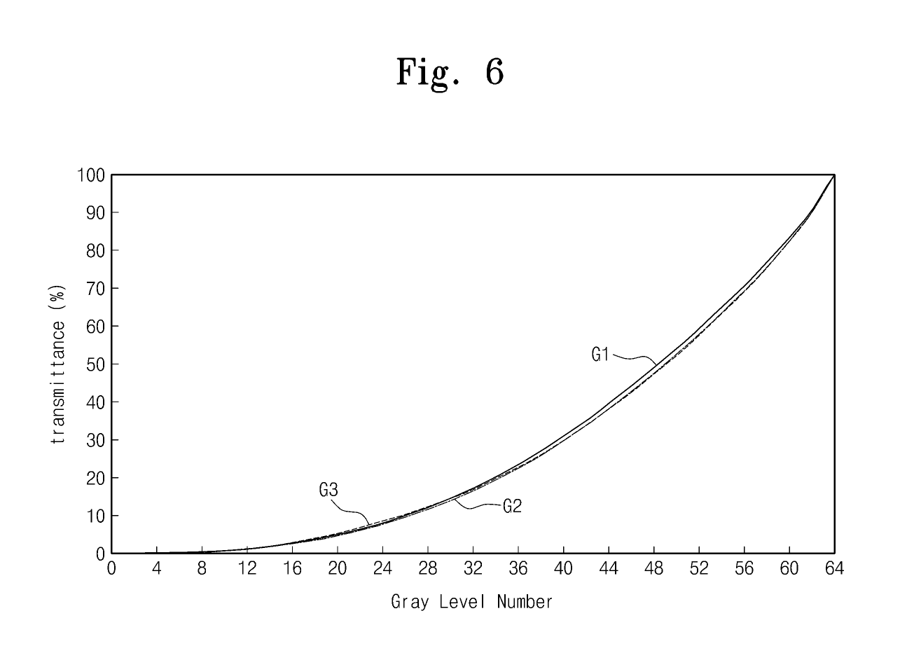

FIG. 6 is a graph illustrating simulation results of transmittance as a function of gray level using 6, 8 and 12 gamma reference voltages. In FIG. 6, a horizontal axis indicates a gray level and a vertical axis indicates a transmittance. Specifically, a first gray level simulation G1 is a simulation result using twelve gamma reference voltages, the second gray level simulation G2 is a simulation result using eight gamma reference voltages, and the third gray level simulation G3 is a simulation result using six gamma reference voltages. The first gray level simulation G1 used twelve gamma reference voltages corresponding to gray levels 0, 8, 16, 32, 48, and 63, respectively. The second gray level simulation G2 used eight gamma reference voltages corresponding to gray levels 0, 8, 48, and 63, respectively. The third gray level simulation G3 used six gamma reference voltages corresponding to gray levels 0, 8, and 63, respectively. By comparing the first gray level simulation G1 with the second and third gray level simulations G2 and G3, it can be understood that the gray level simulations are similarly represented. Therefore, a desired level of transmittance versus gray level can be obtained using only six or eight gamma reference voltages without the need to use 12 or more gamma reference voltages.

According to the above, the number of signal transmission lines in the driving circuit may be reduced, thereby reducing the size of the printed circuit board connecting the timing controller to the data driver. In addition, as the number of the signal transmission lines is reduced, the intervals between the signal transmission lines connected to one driver IC can be wider, to thereby prevent alignment errors occurring when connecting pins of the driver IC to the signal lines.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A driving circuit comprising:
a timing controller which receives an external signal and outputs an image signal and a control signal for a single frame;
a first gamma reference voltage generating circuit which outputs a first gamma reference voltage, a second gamma reference voltage, a third gamma reference voltage and a fourth gamma reference voltage, wherein the third gamma reference voltage and the fourth gamma reference voltage have a different polarity from the first gamma reference voltage and the second gamma reference voltage with respect to a predetermined reference voltage; and
a data driver which receives the first to fourth gamma reference voltages, the image signal, and the control signal and outputs a data voltage,
wherein the data driver comprises:
a second gamma reference voltage generating circuit which outputs at least one fifth gamma reference voltage and at least one sixth gamma reference voltage based on the control signal, wherein the fifth gamma reference voltage has a substantially similar voltage level as one of a voltage level of the first gamma reference voltage, a voltage level of the second gamma reference voltage, and a voltage level between the first gamma reference voltage and the second gamma reference voltage and wherein the sixth gamma reference voltage has a substantially similar voltage level as one of a voltage level of the third gamma reference voltage, a voltage level of the fourth gamma reference voltage, and a voltage level between the third gamma reference voltage and the fourth gamma reference voltage;
a digital-to-analog converter which converts the image signal to a first data voltage based on the first gamma reference voltage, second gamma reference voltage and fifth gamma reference voltage and converts the image signal to a second data voltage based on the third gamma reference voltage, fourth gamma reference voltage, and sixth gamma reference voltage; and
a selector which receives the first data voltage and the second data voltage to output one of the first data voltage and the second data voltage as the data voltage.

2. The driving circuit of claim 1, wherein the control signal comprises a data control signal and a gamma control signal, and the second gamma reference voltage generating circuit outputs the fifth gamma reference voltage and the sixth gamma reference voltage based on the gamma control signal.

3. The driving circuit of claim 2, further comprising a transmission line connecting the timing controller to the data driver to provide the data control signal and the gamma control signal to the data driver during a blank period of an image output cycle and to provide the image signal to the data driver during a data transmission period of the image output cycle.

4. The driving circuit of claim 3, wherein the timing controller further outputs an error detection signal which detects a transmission error in the data control signal and the gamma control signal after an output of the data control signal and the gamma control signal.

5. The driving circuit of claim 4, wherein the data driver repeats an output of a data voltage of a previous frame when the data driver detects the transmission error based on the data control signal, the gamma control signal and the error detection signal.

6. The driving circuit of claim 3, wherein the second gamma reference voltage generating circuit comprises:
a first resistor string comprising a plurality of first resistors connected in series between the first gamma reference voltage and the second gamma reference voltage;
a second resistor string comprising a plurality of second resistors connected in series between the third gamma reference voltage and the fourth gamma reference voltage;
at least one first decoder which outputs a voltage at a node at which the first resistors are connected as the fifth gamma reference voltage in response to the gamma control signal; and
at least one second decoder which outputs a voltage at another node at which the second resistors are connected as the sixth gamma reference voltage in response to the gamma control signal.

7. The driving circuit of claim 3, wherein the digital-to-analog converter comprises:
a third resistor string comprising a plurality of third resistors connected in series between the first gamma reference voltage and the second gamma reference voltage to generate a plurality of first gray scale voltages based on the first gamma reference voltage, the second gamma reference voltage and the fifth gamma reference voltage;
a fourth resistor string comprising a plurality of fourth resistors connected in series between the third gamma reference voltage and the fourth gamma reference voltage to generate a plurality of second gray scale voltages based on the third gamma reference voltage, the fourth gamma reference voltage and the sixth gamma reference voltage;
a first switch circuit which receives the first gray scale voltages from the third resistor string to selectively output a voltage corresponding to the image signal among the first gray scale voltages as the first data voltage; and
a second switch circuit which receives the second gray scale voltages from the fourth resistor string to selectively output a voltage corresponding to the image signal among the second gray scale voltages as the second data voltage.

8. The driving circuit of claim 2, wherein the control signal further comprises a polarity control signal, and the selector is a multiplexer which selects either the first data voltage or the second data voltage in response to the polarity control signal.

9. A display apparatus comprising:
a timing controller which receives an external signal to provide an image signal and a control signal for a single frame;
a display panel which displays an image in response to the image signal;
a first gamma reference voltage generating circuit which outputs a first gamma reference voltage, a second gamma reference voltage, a third gamma reference voltage and a fourth gamma reference voltage, wherein the third gamma reference voltage and the fourth gamma reference voltage having a different polarity from the first gamma reference voltage and the second gamma reference voltage with respect to a predetermined reference voltage; and
a data driver which receives the first to fourth gamma reference voltages, the image signal, and the control signal to generate a data voltage,
wherein the data driver comprises:
a second gamma reference voltage generating circuit which outputs at least one fifth gamma reference voltage and at least one sixth gamma reference voltage based on the control signal, the fifth gamma reference voltage having a substantially same voltage level as a voltage level of the first gamma reference voltage, a voltage level of the second gamma reference voltage, or a voltage level between the first gamma reference voltage and second gamma reference voltage and the sixth gamma reference voltage having a substantially same voltage level as a voltage level of the third gamma reference voltage, a voltage level of the fourth gamma reference voltage, or a voltage level between the third gamma reference voltage and the fourth gamma reference voltage;
a digital-to-analog converter which converts the image signal to a first data voltage based on the first gamma reference voltage, second gamma reference voltage, and fifth gamma reference voltage and converts the image signal to a second data voltage based on the third gamma reference voltage, fourth gamma reference voltage, and sixth gamma reference voltage; and
a selector which receives the first data voltage and the second data voltage to output either the first data voltage or the second data voltage as the data voltage.

10. The display apparatus of claim 9, wherein the control signal comprises a data control signal and a gamma control signal, and the second gamma reference voltage generating circuit outputs the fifth gamma reference voltage and the sixth gamma reference voltage based on the gamma control signal.

11. The display apparatus of claim 10, further comprising a transmission line which connects the timing controller to the data driver to provide the data control signal and the gamma control signal to the data driver during a blank period of an image output cycle and to provide the image signal to the data driver during a data transmission period of the image output cycle.

12. The display apparatus of claim 11, wherein the timing controller further outputs an error detection signal to detect a transmission error in the data control signal and the gamma control signal after an output of the data control signal and the gamma control signal.

13. The display apparatus of claim 12, wherein the data driver repeats an output of a data voltage of a previous frame when the data driver detects the transmission error based on the data control signal, the gamma control signal and the error detection signal.

14. A driving circuit comprising:
a timing controller which receives an external signal to output an image signal and a control signal for a single frame;
a first gamma reference voltage generating circuit which outputs a first gamma reference voltage and a second gamma reference voltage; and
a data driver which receives the first gamma reference voltage and the second gamma reference voltage, the image signal, and the control signal to output a data voltage,
wherein the data driver comprises,
a second gamma reference voltage generating circuit which outputs at least one third gamma reference voltage having a substantially same voltage level as a voltage level of the first gamma reference voltage, a voltage level of the second gamma reference voltage, or a voltage level between the first gamma reference voltage and the second gamma reference voltage; and
a digital-to-analog converter which converts the image signal to the data voltage based on the first to third gamma reference voltages.

15. The driving circuit of claim 14, wherein the control signal comprises a data control signal and a gamma control signal, and the second gamma reference voltage generating circuit outputs the third gamma reference voltage based on the gamma control signal.

16. The driving circuit of claim 15, further comprising a transmission line which connects the timing controller to the data driver to provide the data control signal and the gamma control signal to the data driver during a blank period of an image output cycle and to provide the image signal to the data driver during a data transmission period of the image output cycle.

17. The driving circuit of claim 16, wherein the timing controller further outputs an error detection signal to detect a transmission error in the data control signal and the gamma control signal after an output of the data control signal and the gamma control signal.

18. The driving circuit of claim 17, wherein the data driver repeats an output of a data voltage of a previous frame when the data driver detects the transmission error based on the data control signal, the gamma control signal and the error detection signal.

19. The driving circuit of claim 16, wherein the second gamma reference voltage generating circuit comprises:
a first resistor string comprising a plurality of first resistors connected in series between the first gamma reference voltage and the second gamma reference voltage; and
at least one decoder which outputs a voltage at a nodes at which the first resistors are connected as the third gamma reference voltage in response to the gamma control signal.

20. The driving circuit of claim 16, wherein the digital-to-analog converter comprises:
a second resistor string comprising a plurality of second resistors connected in series between the first gamma reference voltage and the second gamma reference voltage to generate a plurality of gray scale voltages based on the first to third gamma reference voltages; and
a switch circuit which receives the gray scale voltages from the second resistor string to selectively output a voltage corresponding to the image signal among the gray scale voltages as the data voltage.
